(19) United States
(12) Patent Application Publication
(10) Pub. No.: US 2008/0158298 A1
(43) Pub. Date: Jul. 3, 2008

(54) PRINTHEAD WIREBOND ENCAPSULATION

(76) Inventors: Jeffrey P. Serbicki, Holley, NY (US); Randy J. Kennard, Palmyra, NY (US); Douglas L. Morgan, Spencerport, NY (US); Mario J. Ciminelli, Rochester, NY (US); C. Glenn Prince, Palmyra, NY (US)

Correspondence Address: David A. Novais;Patent Legal Staff, Eastman Kodak Company, 343 State Street, Rochester, NY, 14650-2201, US

(21) Appl. No.: 11/617,126

(22) Filed: Dec. 28, 2006

(51) Int. Cl. B41J 2/16

(52) U.S. Cl. 347/50

(57) ABSTRACT

A printhead includes a printhead die and an interconnect substrate. The printhead die includes a surface. The interconnect substrate includes electrical circuitry and a surface. The electrical circuitry is in electrical communication with the printhead die through a plurality of electrical connections. An encapsulant structure is positioned to encapsulate the plurality of electrical connections, and includes a barrier portion and a filler portion. The barrier portion includes a first wall and a second wall. The first wall is in contact with the surface of the printhead die and the second wall is in contact with the surface of the interconnect substrate. The filler portion is in contact with the plurality of electrical connections and positioned between the first wall of the barrier portion and the second wall of the barrier portion.

### FIELD OF THE INVENTION

This invention relates generally to the field of digitally controlled printing devices, and more particularly to encapsulation of electrical connections associated with these devices.

### BACKGROUND OF THE INVENTION

Encapsulation of printhead electrical connections is known, see, for example, U.S. Pat. No. 5,953,032 to Haarz et al., issued Sep. 14, 1999, entitled “Method for forming and inspecting a barrier layer of an ink jet print cartridge,” and U.S. Pat. No. 6,099,109 to Komuro, issued Aug. 8, 2000, entitled “Liquid-ejecting head and method of manufacturing the same.” However, when the encapsulation process is not performed with a sufficient degree of precision, the encapsulating material can migrate to regions of the printhead that include liquid ejection nozzles and drop forming mechanisms, for example, thermal resistor elements, resulting in reduced printhead performance and even printhead operational failure.

In attempt to control migration of the encapsulating material, U.S. Pat. No. 6,099,109 to Komuro discloses including a depression region on an orifice plate of a printhead that defines an area of encapsulation on the printhead. However, forming the depression region in the orifice plate may involve additional manufacturing steps and/or processes resulting in increased printhead fabrication costs.

U.S. Pat. No. 5,953,032 to Haarz et al. discloses a process for forming a barrier layer over one or more extending sections of a flexible circuit and one or more bond pads of a print cartridge printhead using an encapsulant material and subsequently inspecting the print cartridge to determine if the encapsulant material has been properly placed on the print cartridge. The process involves providing an inspection mark on an orifice plate of the printhead before the barrier layer is formed. After the barrier layer has been formed, an inspection is made to determine if the barrier layer extends beyond the inspection mark and contacts a second portion of the print cartridge. If it does, then the print cartridge is unacceptable. If not, then the print cartridge is acceptable. Alternatively, the location of the barrier layer may be considered unacceptable if it contacts any portion of the inspection mark even though it may not contact the second portion of the print cartridge. However, the inclusion of an inspection mark on the printhead may increase printhead fabrication costs and necessitates that each printhead be inspected to determine whether each printhead meets acceptable quality standards.

Encapsulation of electronic device components is also known. For example, U.S. Pat. No. 6,573,328 to Kropp et al., issued Jun. 3, 2003, entitled “Low temperature, fast curing silicone compositions,” discloses two methods of encapsulating a semi-conductor chip that is electrically connected to a circuit board. These methods are commonly referred to as a “glob top” application and a “dam and fill” application.

However, there is still a need to encapsulate printhead electrical connections using a technique that does not require the formation of inspection marks or depressions in the printhead or necessitate inspection of each printhead after the electrical connections of the printhead have been encapsulated.

### SUMMARY OF THE INVENTION

According to one feature of the present invention, a printhead includes a printhead die and an interconnect substrate. The printhead die includes a surface. The interconnect substrate includes electrical circuitry and a surface. The electrical circuitry is in electrical communication with the printhead die through a plurality of electrical connections. An encapsulant structure is positioned to encapsulate the plurality of electrical connections, and includes a barrier portion and a filler portion. The barrier portion includes a first wall and a second wall. The first wall is in contact with the surface of the printhead die and the second wall is in contact with the surface of the interconnect substrate. The filler portion is in contact with the plurality of electrical connections and positioned between the first wall of the barrier portion and the second wall of the barrier portion.

According to another feature of the present invention, a method of manufacturing a printhead includes providing a printhead die including a surface; providing an interconnect substrate including electrical circuitry, the interconnect substrate including a surface, the electrical circuitry being in electrical communication with the printhead die through a plurality of electrical connections; and forming an encapsulant structure positioned to encapsulate the plurality of electrical connections, the encapsulant structure including a barrier portion and a filler portion, the barrier portion including a first wall and a second wall by: positioning the first wall of the barrier portion in contact with the surface of the printhead die; positioning the second wall of the barrier portion in contact with the surface of the interconnect substrate; and positioning the filler portion between the first wall of the barrier portion and the second wall of the barrier portion and in contact with the plurality of electrical connections.

### BRIEF DESCRIPTION OF THE DRAWINGS

In the detailed description of the preferred embodiments of the invention presented below, reference is made to the accompanying drawings, in which:

FIG. 1 is a schematic side view of an example embodiment of the present invention prior to being cured;

FIG. 2 is a schematic perspective view of the example embodiment shown in FIG. 1 after being cured;

FIG. 3 is a schematic perspective view of a prior art configuration of an encapsulant structure with no barrier portion;

FIG. 4 is a schematic top view of an example configuration of the barrier portion of the present invention;

FIG. 5 is a schematic top view of another example configuration of the barrier portion of the present invention;

FIG. 6 is a schematic perspective view of a wiper blade pushing ink toward an encapsulant structure of the present invention;

FIG. 7 is a schematic perspective view of a wiper blade pushing ink across an encapsulant structure of the present invention;

FIG. 8 is a schematic perspective view of a wiper blade pushing ink toward a prior art encapsulant structure with no barrier portion; and

FIG. 9 is a schematic perspective view of a wiper blade pushing ink across a prior art encapsulant structure with no barrier portion.

### DETAILED DESCRIPTION OF THE INVENTION

The present description will be directed in particular to elements forming part of, or cooperating more directly with, apparatus in accordance with the present invention. It is to be understood that elements not specifically shown or described may take various forms well known to those skilled in the art.

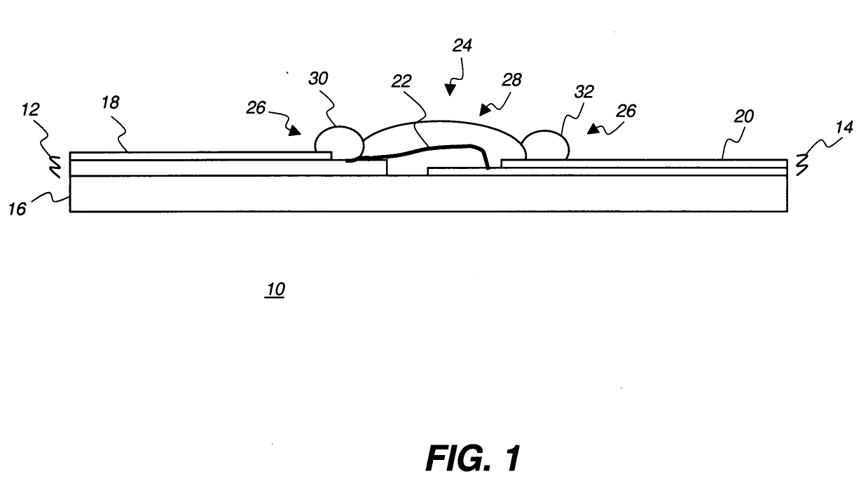

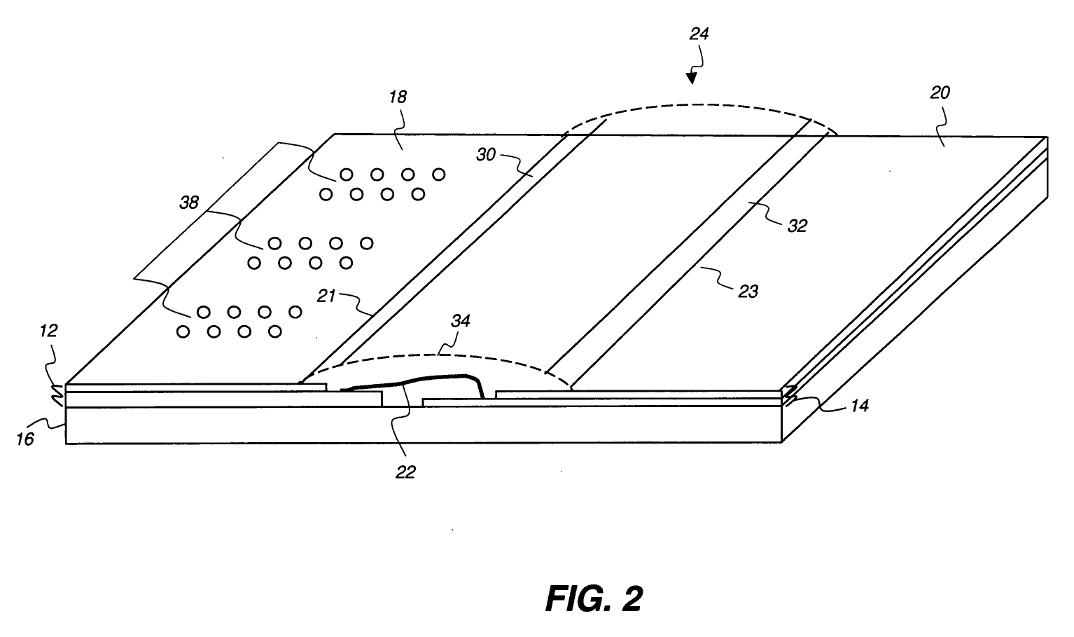

Referring to FIG. 1, a schematic side view of an example embodiment of the present invention is shown. A printhead 10 includes a printhead die 12 and an interconnect substrate 14 located on a support substrate 16. Printhead die 12 includes a surface 18 and is operable to eject liquid, for example, inkjet liquid, through nozzles 38 (shown in FIGS. 2-5) in a conventional manner. Interconnect substrate 14 includes electrical circuitry 42 (a portion of which is shown in FIGS. 2-5) and a surface 20. Electrical circuitry 42 is in electrical communication with printhead die 12 through a plurality of electrical connections 22 only one of which is shown in FIG. 1. Electrical connections 22 can be of the type that are commonly referred to as “wire bonds” although other types of electrical connections can be used with the present invention.

Typically, printhead die 12 is made from a silicon material although printhead die 12 can be made from other materials. Interconnect substrate 14 can be of the type commonly referred to as “a flex circuit,” “flex tape,” or “flex,” however, other types of interconnect substrates can be used with the present invention.

An encapsulant structure 24 is positioned to encapsulate the plurality of electrical connections 22. Encapsulant structure 24 includes a barrier portion 26 and a filler portion 28. Barrier portion 26 includes a first wall 30 and a second wall 32. First wall 30 contacts surface 18 of printhead die 12 while second wall 32 contacts surface 20 of interconnect substrate 14. Filler portion 28 contacts the plurality of electrical connections 22 and is positioned between first wall 30 of barrier portion 26 and second wall 32 of barrier portion 26.

As shown in FIG. 1, barrier portion 26 and filler portion 28 of encapsulant structure 24 are not cured. Typically, first wall 30 and second wall 32 of barrier portion 26 are formed by applying a bead of a first polymer material over surface 18 of printhead die 12 and surface 20 of interconnect substrate 14. The polymer material of barrier portion 26 of encapsulant structure 24 has a first viscosity when the material is uncured. Filler portion 28 is also formed by applying a second polymer material having a second viscosity when the material is uncured and is applied between first wall 30 of barrier portion 26 and second wall 32 of barrier portion 26.

The viscosity of the barrier portion polymer material is greater (or higher) than the viscosity of the filler portion material in the present invention. The higher viscosity barrier portion 26 material helps to prevent excessive or nonuniform flow of the material onto printhead die 12 and/or interconnect substrate 14. This is significant because excessive flow of the material onto printhead die 12 can lead to the nozzles of the printhead becoming plugged by the material. When too many nozzles become plugged, the printhead is considered defective and unusable.

The lower viscosity filler portion 28 polymer material provides acceptable penetration into and around electrical connections 22 without creating material voids or pockets of air in filler portion 28. Material voids and/or air pockets can cause excessive stress on electrical connections 22 leading to premature failure of electrical connections 22 causing the printhead to become defective and unusable.

Curing of the barrier portion and the filler portion of the encapsulant takes place at elevated temperature. As the temperature is raised, and prior to crosslinking of the two materials, both portions become somewhat more flowable. As a result, the overall shape of the encapsulant structure 24 becomes smoother with a more gradual curvature as shown in the perspective view of FIG. 2. The flow of barrier portion 26 is self-limited by the higher viscosity of the first polymer material, while the flow of the filler portion 28 is limited by the presence of the barrier portion 26. Thus, the encapsulant structure 24 has a cross-sectional profile 34 which is relatively flat and low. Encapsulant structure 24 also has well-defined substantially straight edges 21 and 23 that slope up from surfaces 18 and 20 respectively with small angles relative to those surfaces. Such a configuration is compatible with effective wiping and cleaning of the face of the printhead, as will be described later.

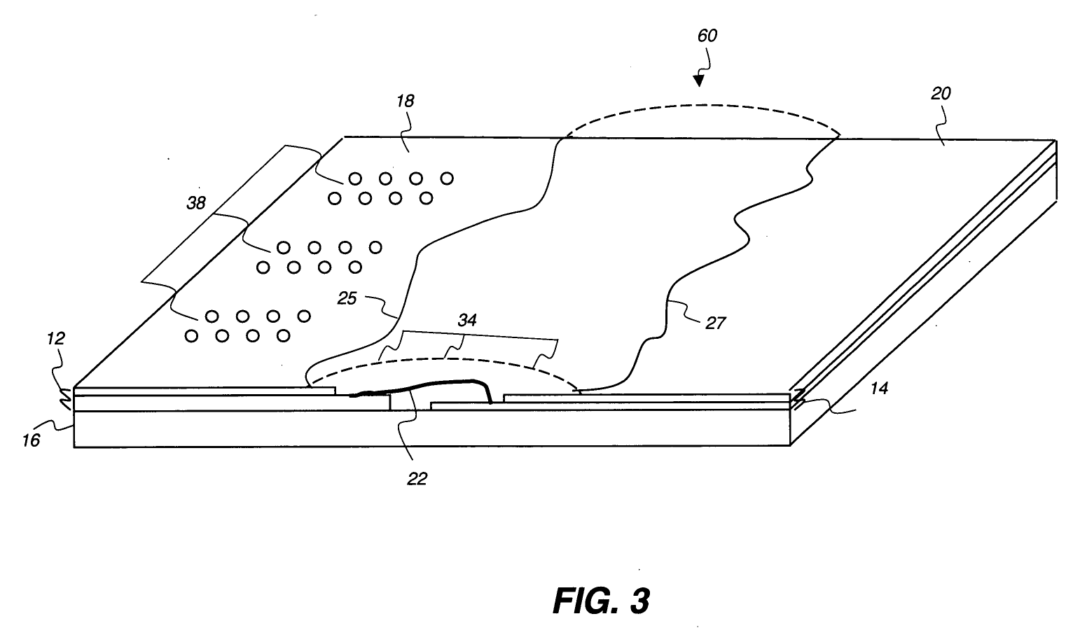

By contrast, FIG. 3 shows a schematic perspective view of a prior art encapsulation structure 60 in which no barrier material was applied to limit the flow. A low viscosity polymer is still required in order to cover the interconnections 22 effectively. However, with no barrier portion, the encapsulant flows in a nonuniform fashion during curing, resulting in the wavy edges 25 and 27.

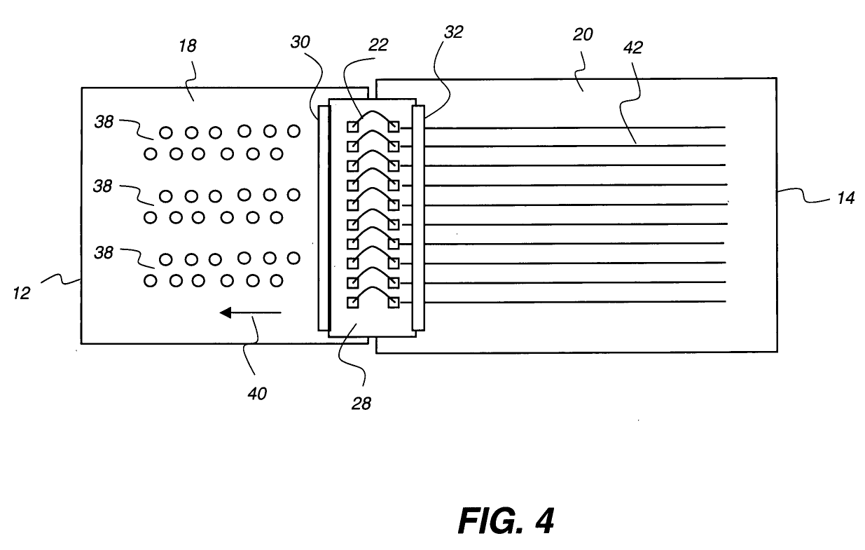

Referring to FIG. 4, a schematic top view of an example configuration of barrier portion 26 is shown. Barrier portion 26 includes a first wall 30 and a second wall 32. First wall 30 contacts surface 18 of printhead die 12 while second wall 32 contacts surface 20 of interconnect substrate 14. In this configuration, typically, filler portion 28 is positioned in contact with first wall 30 of barrier portion 26 and second wall 32 of barrier portion 26 such that filler portion 28 is bounded on two sides by first wall 30 and second wall 32 of barrier portion 26. Portions of electrical circuitry 42 of interconnect substrate 14 and a few of the endmost nozzles 38 of printhead die 12 are also shown.

Circuitry 42 can include electrical leads from the region pads to which interconnections 22 are bonded to a second region (not shown) where connection pads from the printhead to the printer are located. However, other types of circuitry 42 can be encapsulated using the present invention. In the nozzle configuration shown in FIGS. 4-9, there are several groupings of nozzles, which would typically extend further in array direction 40 in the figures. The three groupings of nozzles may each be for a different color. The nozzles are shown as staggered within a grouping in order to provide higher resolution printing. It is to be understood that the nozzle configuration is not an essential feature of this invention. However, it is desirable for the encapsulant material to stay well away from the nozzle region.

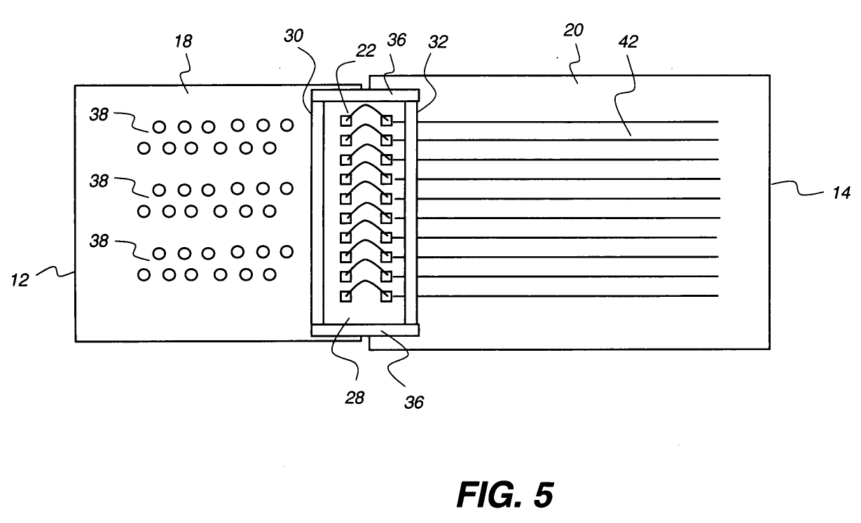

Referring to FIG. 5, a schematic top view of another example configuration of barrier portion 26 is shown. Barrier portion 26 includes a first wall 30 and a second wall 32. First wall 30 contacts surface 18 of printhead die 12 while second wall 32 contacts surface 20 of interconnect substrate 14. Barrier portion 26 also includes at least one additional wall 36 in contact with surface 18 of printhead die 12 and surface 20 of interconnect substrate 14. As shown in FIG. 5, there are two of these additional walls 36. However, more than two or less than two additional walls 36 can be used. In this configuration, filler portion 28 is positioned between first wall 30, second wall 32, and the at least one additional wall 36 of barrier portion 26. Filler portion 28 can contact each wall 30, 32, and 36 such that filler portion 28 is bounded on at least three sides by first wall 30, second wall 32, and at least one additional wall 36 of barrier portion 26 as shown in FIG. 5.

In another example embodiment of barrier portion 26, barrier portion 26 can be a prefabricated frame including, for example, first wall 30, second wall 32, and two additional walls 36 that is affixed to surface 18 of printhead die 12 and surface 20 of interconnect substrate 14. The prefabricated frame of barrier portion 26 can be affixed using conventional adhesive or after the material forming the prefabricated frame has been partially cured. Filler portion 28 is added after barrier portion 26 has been affixed to surfaces 18 and 20.

Regardless of the specific configuration of barrier portion 26, one wall, for example, first wall 30, is positioned between the plurality of electrical connections 22 and nozzles 38 arranged along an array direction 40 on printhead die 12. This helps to control the position of lower viscosity filler portion 28 material and reduce the likelihood of lower viscosity filler portion 28 material migrating toward nozzles 38. As shown in FIGS. 4 and 5, first wall 30 is positioned on surface 18 of printhead die 12 such that first wall 30 is located substantially perpendicular to array 40.

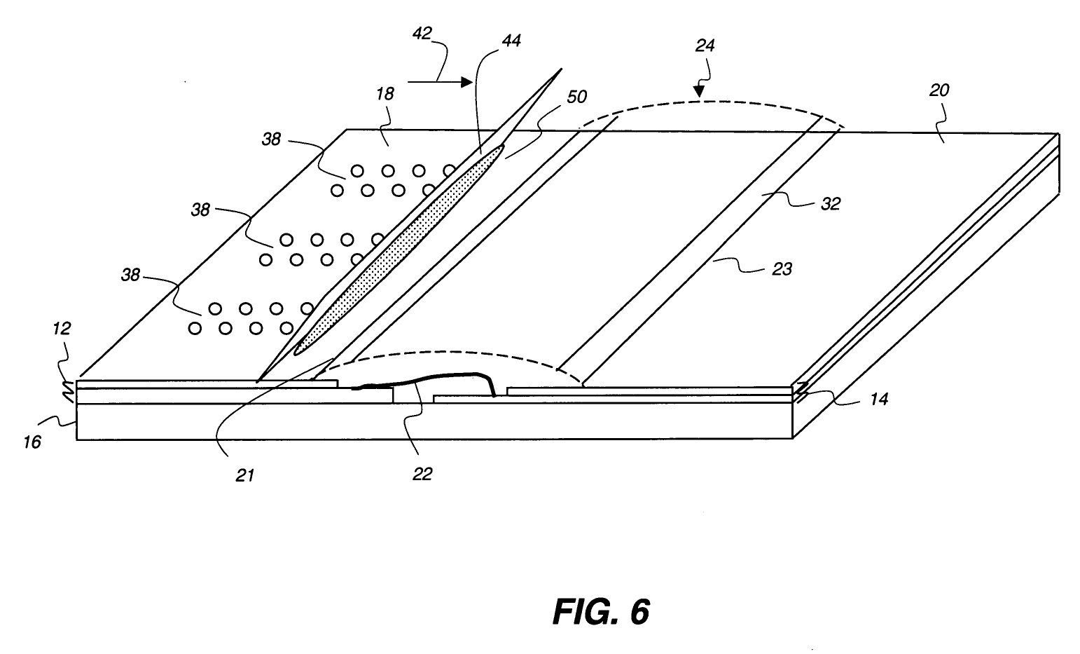

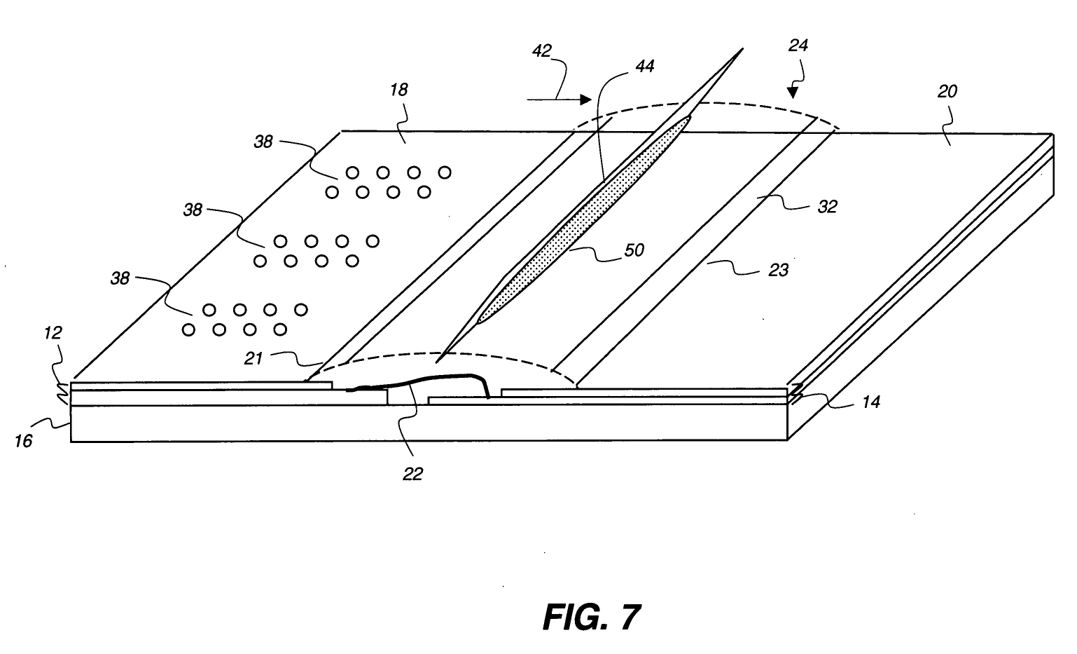

FIGS. 6 and 7 show schematic perspective views of printhead 10 (with encapsulation structure 24 of the present invention) being cleaned by an elastomeric wiper blade 44, of a cleaning mechanism for example, in a printing system (not shown). Wiper blade 44 is moved in direction 42 across surface 18 of printhead die 12 so that a puddle of ink 50 is pushed away from the nozzles 38. Some of the ink 50 is on surface 18, while some of the ink is on the wiper blade 44. It is desired to move the ink over the encapsulant structure in such a way that the ink remains substantially on the wiper blade 44. After the wiper blade passes the printhead, it typically encounters a scraper (not shown) which removes ink from the blade.

As the edge 21 of encapsulant structure 24 of the present structure is substantially straight and has a low entry angle with respect to surface 18, the blade is able to deform uniformly in passing over the encapsulant structure, so that a good seal remains between the tip of blade 44 and the surface of the printhead 10. As a result, blade 44 is in substantially continuous contact with the printhead surface (until it leaves the printhead for the scraper) and is able to push substantially the entire puddle of ink 50 over the encapsulant structure 24 as shown in FIG. 7. As exit edge 23 is also substantially straight and with a low exit angle, the ink continues to be pushed off printhead 10 (not shown).

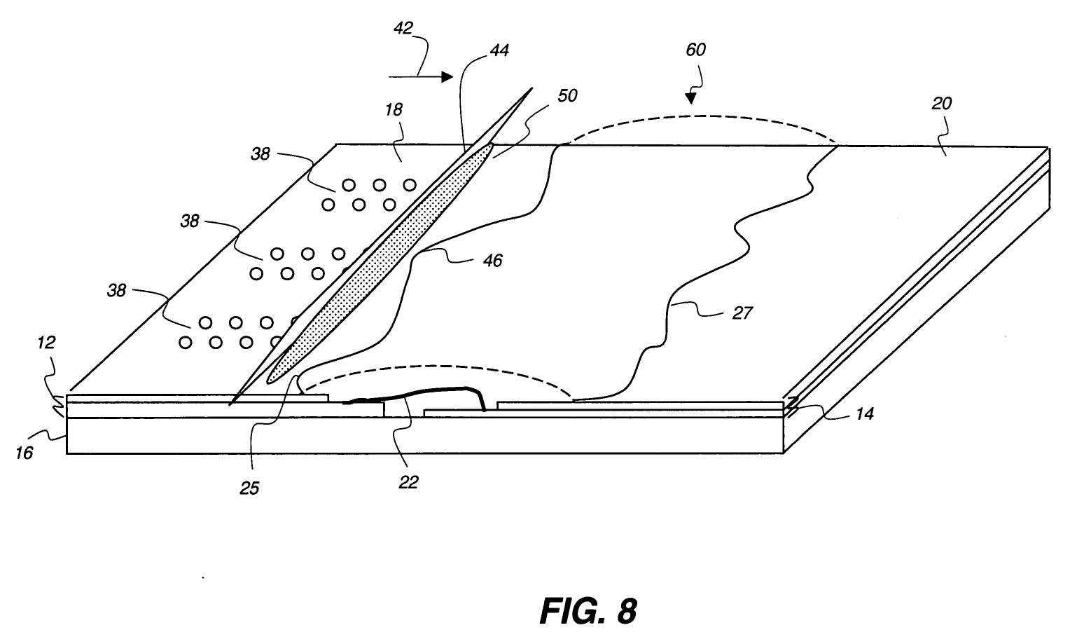

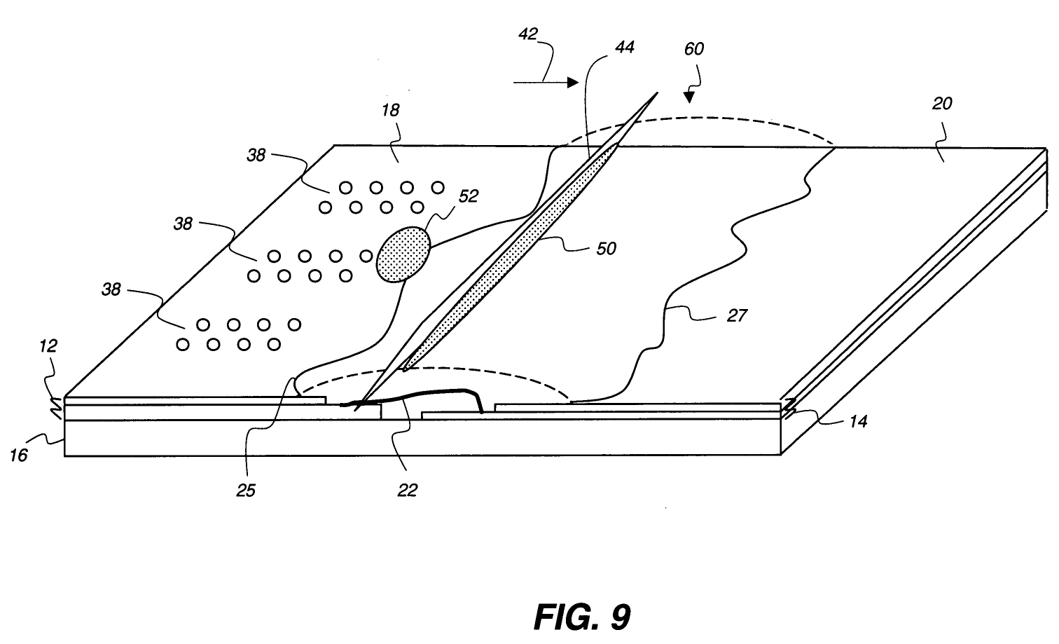

By contrast, FIGS. 8 and 9 show schematic perspective views of printhead 10 (with prior art encapsulation structure 60) being cleaned by an elastomeric wiper blade 44. Wiper blade 44 is moved in direction 42 across surface 18 of printhead die 12 so that a puddle of ink 50 is pushed away from the nozzles 38. Some of the ink 50 is on surface 18, while some of the ink is on the wiper blade 44. The edge 25 of prior art encapsulant structure 60 is wavy, so the blade deforms nonuniformly in passing over the encapsulant structure 60 (first lifting up at forwardmost point 46). This causes the seal between the tip of blade 44 and the surface of the printhead 10 to be partially interrupted. As a result of this noncontinuous contact, a residue of ink 52 is left behind on printhead die surface 18, as shown in FIG. 9. Because exit edge 27 is also wavy, a residue of ink (not shown) may also be left on surface 20 of interconnect structure 14.

Encapsulating the plurality of electrical connections 22 can be accomplished using the following manufacturing method. Printhead die 12 including surface 18 is provided. Interconnect substrate 14 including electrical circuitry 42 and surface 20 is provided. Electrical circuitry is connected in electrical communication with the printhead die through a plurality of electrical connections 22. Electrical connections 22 can be formed, for example, using a wire bonding process.

Encapsulant structure 24, positioned to encapsulate the plurality of electrical connections 22, is then formed. Encapsulant structure 24 includes a barrier portion 26 and a filler portion 28. Barrier portion 26 includes a first wall 30 and a second wall 32. First wall 30 is positioned in contact with surface 18 of printhead die 12. Second wall 32 is positioned in contact with surface 20 of interconnect substrate 14. Filler portion 28 is positioned between first wall 30 and second wall 32 in contact with the plurality of electrical connections 22. First wall 30 and second wall 32 can be formed by applying a material having a first viscosity to surface 18 of printhead die 12 and surface 20 of interconnect substrate 14. Filler portion 28 can be formed by applying a material having a second viscosity between first wall 30 and second wall 32 of barrier portion 26 and in contact with the plurality of electrical connections 22. The first viscosity material used for barrier portion 26 is greater than the second viscosity material used for filler portion 28. The second viscosity material is applied after the first viscosity material. After both materials have been applied to printhead 10, the materials are cured using a conventional curing process. Curing of the material can be accomplished by, but is not limited to, the following methods: a) thermally using ovens of various configurations and types; b) ultraviolet and/or visible light emitted from sources of various configurations and types; c) any combination of a) and b); or d) microwave radiation. Examples of material that are suitable for use in barrier portion 26 include reactive polymer systems such as epoxies, urethanes, silicones, and acrylics, plus particulate filler additives such as silica, silicates metal oxides and polymers. The purpose of the particulate fillers is to modify the viscosity and rheology of the uncured resin, as well as to modify the hardness, thermal conductivity and thermal expansion of the cured material.

Examples of material that are suitable for use in filler portion 28 include similar types of materials as are listed above for use in barrier portion 26. The difference is that a lower viscosity material is used for filler portion 28. This maybe accomplished by using different polymers (either dissimilar chemically or similar chemically but with different molecular weights), or by adding diluents, and/or by using different amounts of particulate filler additives.

Typically, barrier and filler materials are dispensed using automated dispensing systems including a reservoir to hold the material, a dispensing pump to control the flow of the material and/or extrude the material and a mechanism to move the pump over the substrate target area, although other processes can be used.

The invention has been described in detail with particular reference to certain preferred embodiments thereof, but it will be understood that variations and modifications can be effected within the scope of the invention.

### Parts List

10 printhead
12 printhead die
14 interconnect substrate
16 support substrate
18 surface
20 surface
21 straight edges
22 electrical connections
23 straight edges
24 encapsulant structure
25 wavy edges
26 barrier portion
27 wavy edges
28 filler portion
30 first wall
32 second wall
34 cross-sectional profile
36 additional wall
38 nozzles
40 array direction
42 electrical circuitry
44 elastomeric wiper blade
46 forwardmost point
50 ink
52 ink
60 prior art encapsulation structure

1. A printhead comprising:
a printhead die including a surface;
an interconnect substrate including electrical circuitry, the interconnect substrate including a surface, the electrical circuitry being in electrical communication with the printhead die through a plurality of electrical connections;
an encapsulant structure positioned to encapsulate the plurality of electrical connections, the encapsulant structure including a barrier portion and a filler portion, the barrier portion including a first wall and a second wall, the first wall being in contact with the surface of the printhead die, the second wall being in contact with the surface of the interconnect substrate, and the filler portion being in contact with the plurality of electrical connections and positioned between the first wall of the barrier portion and the second wall of the barrier portion.

2. The printhead of claim 1, wherein the filler portion is in contact with the first wall of the barrier portion and the second wall of the barrier portion such that the filler portion is bounded on two sides by the first wall of the barrier portion and the second wall of the barrier portion.

3. The printhead of claim 2, the barrier portion including at least one additional wall in contact with the surface of the printhead die and the surface of the interconnect substrate, wherein the filler portion is in contact with the at least one additional wall of the barrier portion such that the filler portion is bounded on at least three sides by the first wall of the barrier portion, the second wall of the barrier portion, and the at least one additional wall of the barrier portion.

4. The printhead of claim 1, the barrier portion including at least one additional wall in contact with the surface of the printhead die and the surface of the interconnect substrate, wherein the filler portion is positioned between the first wall of the barrier portion, the second wall of the barrier portion, and the at least one additional wall of the barrier portion.

5. The printhead of claim 1, the barrier portion of the encapsulant structure being made from a material having a viscosity when the material is uncured, the filler portion of the encapsulant structure being made from a material having a viscosity when the material is uncured, wherein the viscosity of the barrier portion material is greater than the viscosity of the filler portion material.

6. The printhead of claim 1, the printhead die including a plurality of nozzles arranged on the surface of the printhead die in an array, each of the nozzles of the array being operable to eject an inkjet liquid, wherein the first wall of the barrier portion is positioned between the plurality of electrical connections and the nozzle array.

7. The printhead of claim 1, wherein the plurality of electrical connections are wire bonds.

8. The printhead of claim 1, wherein the printhead die is a silicon material.

9. The printhead of claim 1, the encapsulant structure having a cured cross sectional profile, wherein the cured cross sectional profile of the encapsulant is sufficient to permit substantially continuous contact of the surface of the printhead by a cleaning mechanism.

10. A method of manufacturing a printhead comprising:
providing a printhead die including a surface;
providing an interconnect substrate including electrical circuitry, the interconnect substrate including a surface, the electrical circuitry being in electrical communication with the printhead die through a plurality of electrical connections; and
forming an encapsulant structure positioned to encapsulate the plurality of electrical connections, the encapsulant structure including a barrier portion and a filler portion, the barrier portion including a first wall and a second wall by:
positioning the first wall of the barrier portion in contact with the surface of the printhead die;
positioning the second wall of the barrier portion in contact with the surface of the interconnect substrate; and
positioning the filler portion between the first wall of the barrier portion and the second wall of the barrier portion and in contact with the plurality of electrical connections.

11. The method of claim 10, wherein positioning the first wall of the barrier portion in contact with the surface of the printhead die and positioning the second wall of the barrier portion in contact with the surface of the interconnect substrate includes applying a material having a first viscosity to the surface of the printhead die and the surface of the interconnect substrate, and positioning the filler portion between the first wall of the barrier portion and the second wall of the barrier portion and in contact with the plurality of electrical connections includes applying a material having a second viscosity between the first wall of the barrier portion and the second wall of the barrier portion and in contact with the plurality of electrical connections, the first viscosity being greater than the second viscosity.

12. The method of claim 11, further comprising:
curing the material having the first viscosity and curing the material having the second viscosity.

13. The method of claim 11, wherein applying the material having the second viscosity occurs after applying the material having the first viscosity.
